(19) United States
(12) Patent Application Publication
(10) Pub. No.: US 2016/0277220 A1
(43) Pub. Date: Sep. 22, 2016

(54) PATTERN-BASED COEFFICIENT ADAPTATION OPERATION FOR DECISION FEEDBACK EQUALIZATION

(71) Applicants: Yahuan LIU, San Diego, CA (US); Qing SHI, San Diego, CA (US); Robert Yongli WEN, San Diego, CA (US); James Qian ZHANG, San Diego, CA (US); QUALCOMM INCORPORATED, San Diego, CA (US)

(72) Inventors: Yahuan Liu, Shanghai (CN); Qing Shi, Shanghai (CN); Robert Yongli Wen, San Diego, CA (US); James Qian Zhang, San Diego, CA (US)

(21) Appl. No.: 15/032,620

(22) PCT Filed: Dec. 5, 2013
(86) PCT No.: PCT/CN2013/088627

§ 371 Date: Apr. 27, 2016

(51) Int. Cl. H04L 25/03; H04B 1/06

(52) U.S. Cl. CPC H04L 25/03057; H04B 1/06

(57) ABSTRACT

A method for operating a receiver is disclosed. The receiver may receive, over a channel from a transmitter, a first data bit at a first period of time. The receiver may receive, over the channel, a second data bit at a second period of time subsequent to the first period of time. The first and second data bits each have either a first logical value corresponding to a voltage greater than zero volts or a second logical value corresponding to a voltage less than or equal to zero volts. The receiver performs a coefficient adaptation operation, using the first data bit, to adjust one or more coefficients of a decision feedback equalizer of the receiver only when the logical value of the first data bit is equal to the logical value of the second data bit.

### TECHNICAL FIELD

The present embodiments relate generally to decision feedback equalization, and specifically to performing a coefficient adaptation process for decision feedback equalization.

### BACKGROUND OF RELATED ART

Decision feedback equalization may be used by a receiver of a network-enabled device to eliminate interference, such as intersymbol interference, that is caused by characteristics of a communication channel. For example, in some cases, an analog to digital converter (ADC) of the receiver converts a received analog signal to a digital signal, and a decision feedback equalizer (DFE) of the receiver equalizes the digital signal to compensate for the interference. The DFE performs the equalization by adjusting one or more coefficients to adapt to one or more values in order to offset the error caused by the communication channel. For high-speed applications, however, it may be difficult to use an ADC in conjunction with the DFE in a receiver (e.g., because of switching speed limitations of the ADC).

In addition, while a typical DFE may compensate for interference caused by a post-cursor (i.e., a portion of a signal pulse previously received by the receiver that interferes with the currently received signal pulse), the typical DFE may not compensate for interference caused by a pre-cursor (i.e., a portion of the subsequent signal pulse relative to the currently received signal pulse that has yet to be received by the receiver, but that interferes with the currently received signal pulse). A large pre-cursor may prevent the coefficients of the DFE to adapt to stable values.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

A receiver and method are disclosed that control the coefficient adaptation process of a decision feedback equalizer (DFE) in order to mitigate the effects of intersymbol interference (ISI) caused by the presence of a pre-cursor. In some embodiments, the receiver receives, over a communication channel from a transmitter, a first data bit at a first period of time, and a second bit at a second period of time subsequent to the first period of time. Each of the first bit and the second bit may have either a first logical value (corresponding to a voltage greater than zero volts) or a second logical value (corresponding to a voltage less than or equal to zero volts). The receiver performs a coefficient adaptation operation, using the first data bit, to adjust one or more coefficients of the DFE only when the logical value of the first data bit is equal to the logical value of the second data bit. As an alternative embodiment, the receiver may perform a coefficient adaptation operation, using the first data bit, to adjust one or more coefficients of the DFE only when the logical value of the first data bit is opposite the logical value of the second data bit.

Depending on implementation, in at least one embodiment, the receiver may include a DFE that has a pattern identify component. The pattern identify component maybe implemented as part of the DFE to compare the logical value of the first data bit and the logical value of the second data bit, and to cause the DFE to perform a coefficient adaptation operation when the logical value of the first data bit is equal to the logical value of the second data bit. In another embodiment, the receiver may include a controller that is coupled to the DFE and that implements the pattern identify component on behalf of the DFE. In either embodiments, the pattern identify component may generate an enable signal (e.g., a trigger) for the DFE to enable the DFE to perform the coefficient adaptation operation. In this manner, the receiver may control the coefficient adaptation process of its DFE so that the coefficient(s) of the DFE adapt to the appropriate values efficiently.

### BRIEF DESCRIPTION OF THE DRAWINGS

The present embodiments are illustrated by way of example and are not intended to be limited by the figures of the accompanying drawings, where like reference numerals refer to corresponding parts throughout the drawing figures.

FIG. 1 is a block diagram of a receiver within which the present embodiments may be implemented.

FIG. 2A is a block diagram of a decision feedback equalizer in accordance with some embodiments.

FIG. 2B is a block diagram of a decision feedback equalizer in accordance with other embodiments.

FIG. 3A is an illustrative flow chart depicting an operation of a receiver in accordance with some embodiments.

FIG. 3B is an illustrative flow chart depicting an operation of a receiver in accordance with other embodiments.

FIG. 4 is a block diagram of another receiver within which the present embodiments may be implemented.

FIG. 5 is a block diagram of a network-enabled device in accordance with some embodiments.

### DETAILED DESCRIPTION

In the following description, numerous specific details are set forth such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. The present embodiments are not to be construed as limited to specific examples described herein but rather to include within their scopes all embodiments defined by the appended claims.

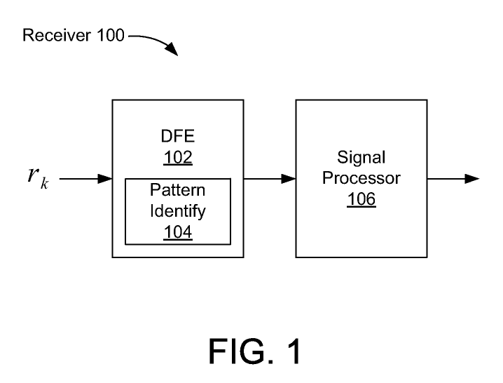

FIG. 1 is a block diagram of a receiver 100 in accordance with the present embodiments. In one embodiment, the receiver 100 may be provided as part of a network-enabled device that may communicate, over a communication channel, with another network-enabled device. The receiver 100 may include a decision feedback equalizer (DFE) 102 and a signal processor 106. The DFE 102 may include a pattern identify component 104. According to some embodiments, the network-enabled device may be, for example, a computer, a laptop, a smart phone or cell phone, a personal digital assistant (PDA), table device, switch, router, hub, gateway, or the like.

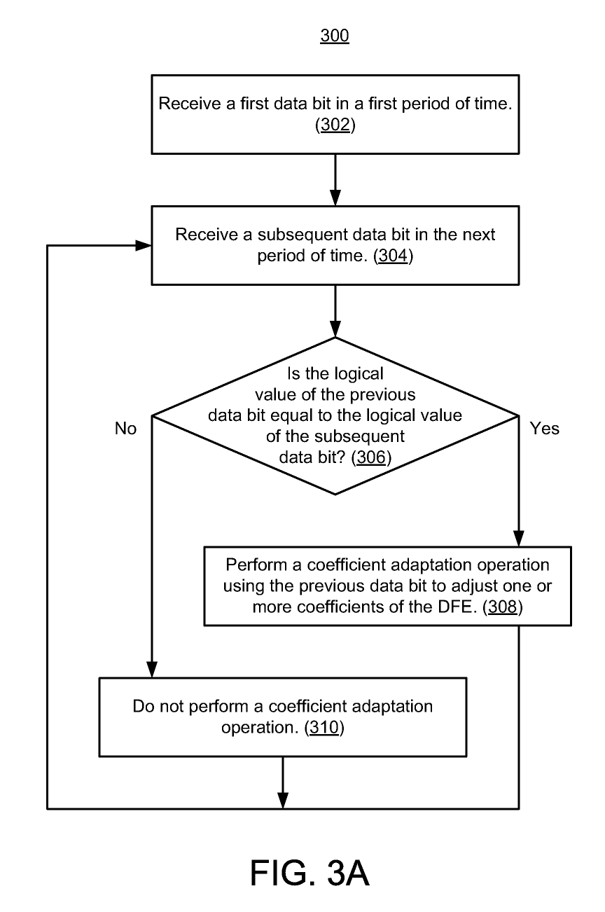

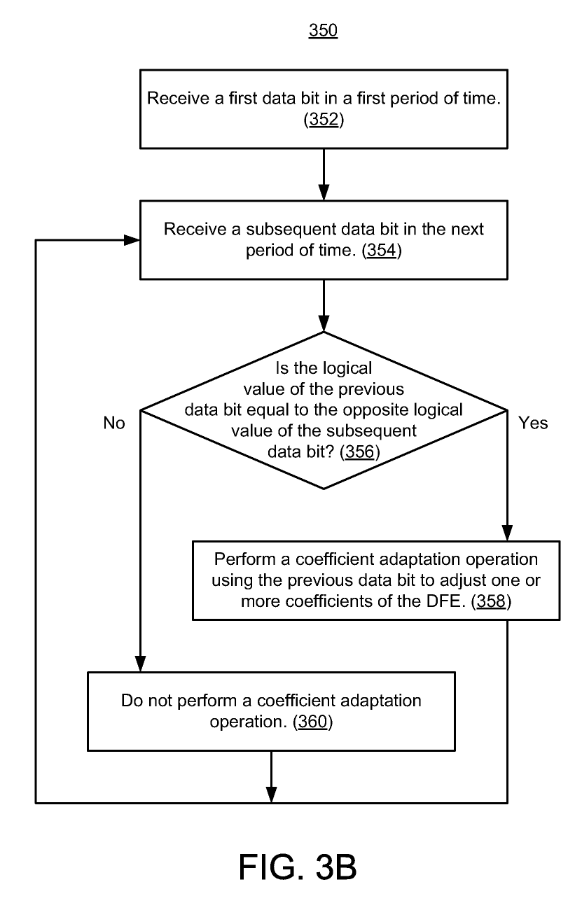

The network-enabled device may also include one or more processing resources, one or more memory resources, and a power source (e.g., a battery) (not shown in FIG. 1) that are coupled to the receiver 100. Depending on implementation, the memory resources may include a non-transitory computer-readable medium (e.g., one or more nonvolatile memory elements, such as EPROM, EEPROM, Flash memory, a hard drive, etc.) that stores instructions for performing operations described below with respect to, for example, FIGS. 3A and 3B.

The receiver 100 may receive data from a transmitter of another network-enabled device over a communication channel (not shown for simplicity). Due to characteristics of the channel, however, intersymbol interference (ISI) may occur that distorts the signal(s) received by the receiver 100. For example, when a transmitter of the other network-enabled device sends a rectangular pulse having a voltage for a period of time, T, over the channel to the receiver 100, the characteristics of the communication channel may cause the rectangular pulse to be distorted so that the receiver 100 actually receives a pulse signal having a period that is larger than T (e.g., such as 3T). As a result, when a first bit is transmitted to the receiver 100, a portion of the pulse of the first bit (e.g., a post-cursor of the first bit) may interfere with a second bit that is subsequently transmitted to the receiver 100. Similarly, a portion of the pulse of the second bit that has not yet been received by the receiver 100 (e.g., a pre-cursor of the second bit) may interfere with the pulse of the first bit. In some cases, when a pre-cursor of the subsequent bit is large (e.g., exceeds some threshold), the pre-cursor may have a detrimental effect on the coefficient adaptation process of the DFE 102.

In the example of FIG. 1, the receiver 100 may receive a data signal, such as a pulse for a bit, having a voltage amplitude, rₖ, at a first period of time. The voltage amplitude, rₖ, of the received bit at a particular instance of time, tₖ, may be the sum of the voltage of the received bit and the voltage of the portions of pulses associated with one or more previously received bits and/or the voltage of the portions of pulses associated with one or more subsequent bits (that have not yet been received at time, tₖ).

Typically, each time the DFE 102 receives data bits from a transmitter of another device over the communication channel, the DFE 102 may perform a coefficient adaptation operation to adjust one or more coefficients, cₖ(n), where n corresponds to an integer representing the number of coefficients, in order to minimize the ISI that a transmitted bit causes on the next adjacent transmitted bit. As described herein, the coefficient adaptation operation corresponds to an operation by the DFE 102 in which the one or more coefficients, cₖ(n), may be adjusted based on the received data bit and a quantized error value, q(εₖ). When the one or more coefficients, cₖ(n), are each adjusted to a stable value (e.g., each of the coefficient(s) adapts to a particular value), the DFE 102 has properly compensated for the ISI caused by the communication channel. In the example of FIG. 1, the pattern identify component 104 may determine when the DFE 102 performs the coefficient adaptation operation for the receiver 100.

For at least some embodiments, the pattern identify component 104 receives a first processed data bit, \hat{d}ₖ, (e.g., processed by the DFE 102) at a first period of time, and then receives the next, subsequently processed data bit, \hat{d}ₖ₊₁, at the next time period. As discussed above, in some cases, the subsequently processed data bit, \hat{d}ₖ₊₁, may have a pre-cursor large enough to interfere with the first processed data bit, \hat{d}ₖ, and thus may heavily influence the quantized error value, q(εₖ), of the first processed data bit, \hat{d}ₖ. Typically, such pre-cursors may be detrimental to the coefficient adaptation process of the DFE 102 by preventing the one or more coefficients, cₖ(n), from quickly adapting to the proper value(s) (e.g., more iterations of the coefficient adaptation operation is required to adapt to the proper value(s)). The pattern identify component 104 may reduce or eliminate the effect of the pre-cursor on the quantized error value, q(εₖ), by enabling the DFE 102 to perform the coefficient adaptation operation only when the logical value of the first processed data bit is equal to the logical value of the second processed data bit (i.e., when \hat{d}ₖ=\hat{d}ₖ₊₁).

If the pattern identify component 104 determines that the logical value of the first processed data bit (e.g., a logical value of one or zero) is equal to the logical value of the second processed data bit, then the pattern identify component 104 may transmit a trigger or enable signal to cause the DFE 102 to perform the coefficient adaptation operation (e.g., use the first data bit and the quantized error value, q(εₖ), to adjust one or more coefficients, cₖ(n), of the DFE 102). On the other hand, if the logical value of the first processed data bit is opposite the logical value of the second processed data bit, then the DFE 102 does not perform the coefficient adaptation operation, and the one or more coefficients, cₖ(n), remain the same until the next pattern is detected by the pattern identify component 104. In this manner, the presence of a large pre-cursor will not have a detrimental effect on the quantized error value, q(εₖ), for purposes of the coefficient adaptation operation of the DFE 102.

For at least one alternative embodiment, the pattern identify component 104 may enable the DFE 102 to perform the coefficient adaptation operation only when the logical value of the first processed data bit is opposite the logical value of the second processed data bit (when \hat{d}ₖ=−\hat{d}ₖ₊₁). In this example, the pattern identify component 104 may transmit a trigger or enable signal to cause the DFE 102 to perform the coefficient adaptation operation (e.g., use the first data bit and the quantized error value, q(εₖ), to adjust one or more coefficients, cₖ(n), of the DFE 102) when the logical value of the first processed data bit is opposite the logical value of the second processed data bit.

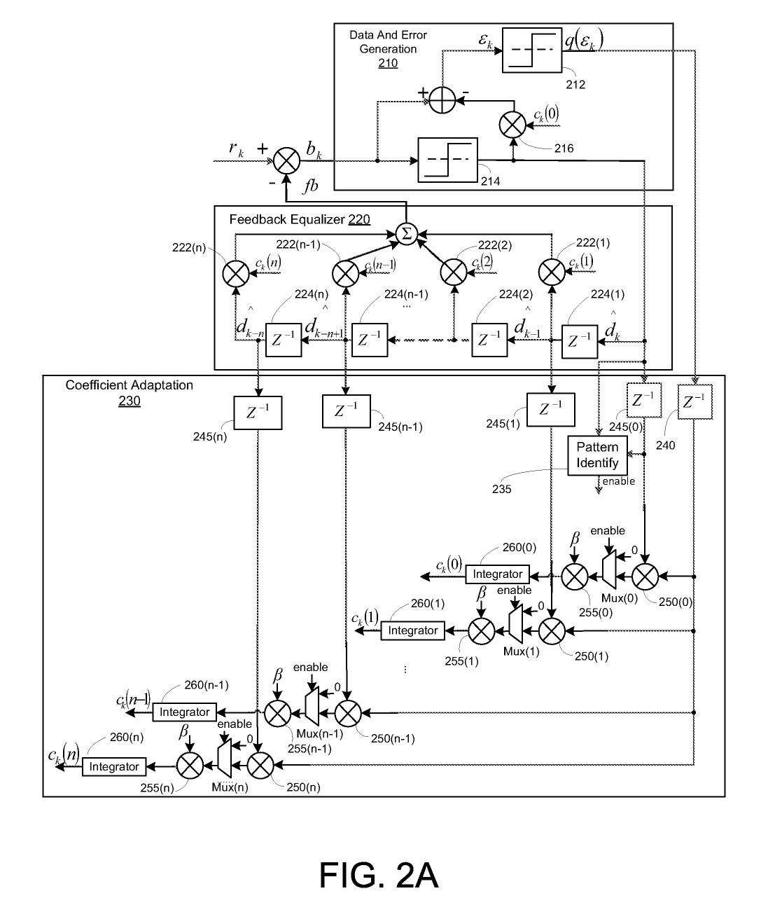

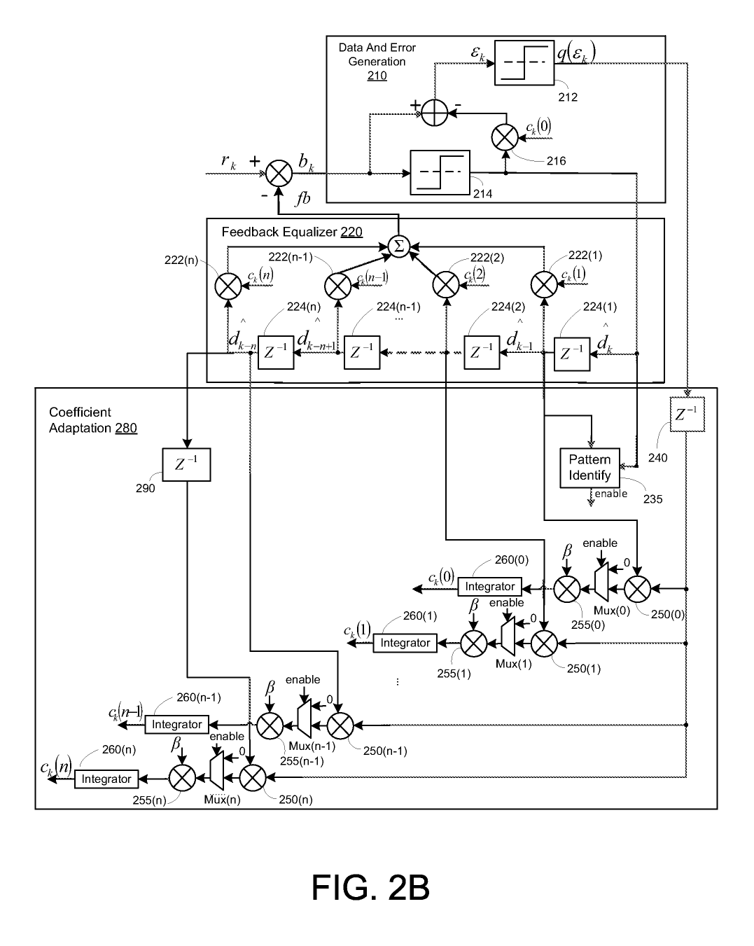

FIG. 2A illustrates an example of a DFE 200, such as the DFE 102 of the receiver 100 of FIG. 1. In one embodiment, the DFE 200 includes a data and error generation component 210, a feedback equalizer component 220, and a coefficient adaptation component 230. The data and error generation component 210 and the feedback equalizer component 220 may correspond to analog components, while the coefficient adaptation component 230 may correspond to a digital component. The coefficient adaptation component 230 may also include a pattern identify component 235, such as the pattern identify component 104 as described in FIG. 1.

The data and error generation component 210 processes a received data bit having a voltage amplitude, rₖ, at time, tₖ, and determines an error value, εₖ, based on feedback information. In some cases, because the exact error value, εₖ, may be difficult to determine in a high-speed serial communication, for example, the data and error generation component 210 may quantize the error value, εₖ, to determine the quantized error value, q(εₖ), using a slicer 212. For example, the quantized error value, q(εₖ), may be expressed as follows:

$$q ( {ɛ}_{k} ) = \{ \begin{matrix}+ 1 , & {ɛ}_{k} \geq 0 \\ - 1 , & {ɛ}_{k} < 0\end{matrix} \qquad ( Eq . 1 )$$

so that the quantized error value, q(εₖ), may be used by the coefficient adaptation component 230 in performing the coefficient adaptation operations. The data and error generation component 210 may also process the received data bit having a voltage amplitude, rₖ, at time, tₖ, to determine a processed data bit, \hat{d}ₖ, by adjusting the received data bit based on the feedback information (e.g., from the feedback equalizer component 220) and by using a suitable slicer 214. Each received and processed data bit, \hat{d}ₖ, may have a logical value of one (corresponding to a voltage greater than zero volts) or a logical value of zero (corresponding to a voltage less than or equal to zero volts). In another example, the logical value of one can correspond to a voltage less than or equal to zero volts, and the logical value of zero can correspond to a voltage greater than zero volts.

The feedback equalizer component 220 includes a plurality of mixers 222(1)-222(n) and a plurality of delay stage components 224(1)-224(n) that each introduces a delay of one period (illustrated as Z⁻¹). Each of the mixers 222(1)-222(n) of the feedback equalizer component 220 (as well as the mixer 216 of the data and error generation component 210) applies a weight to a processed data bit, \hat{d}ₖ, or to one of a plurality of delayed processed data bits using a plurality of coefficients, cₖ(n). For example, the mixer 216 of the data and error generation component 210 applies a weight to the processed data bit, \hat{d}ₖ, using a value of the coefficient cₖ(0); a first mixer 222(1) of the feedback equalizer component 220 applies a weight to the processed data bit that is delayed by one period, \hat{d}ₖ₋₁, using a value of the coefficient cₖ(1); a second mixer 222(2) of the feedback equalizer component 220 applies a weight to the processed data bit delayed by two periods, \hat{d}ₖ₋₂, using a value of the coefficient cₖ(2), etc. The feedback equalizer component 220 then combines the output of the first mixer 222(1), the second mixer 222(2), etc., of the feedback equalizer component 220 to provide a feedback signal to the data and error generation component 210.

The coefficient adaptation component 230 may perform the coefficient adaptation operations for the DFE 200. In some embodiments, each time the coefficient adaptation component 230 performs a coefficient adaptation operation (using a received processed data bit and the error information for the data bit), the coefficient adaptation component 230 may adjust one or more of the plurality of coefficients, cₖ(n), so that each of the coefficients, cₖ(n), may stabilize to a particular value. In this manner, the coefficients, cₖ(n), may adapt to the appropriate values to minimize the error caused by the communication channel characteristics. In embodiments described herein, the coefficient adaptation component 230 may perform a coefficient adaptation operation based on data received by the pattern identify component 235, as discussed below.

According to at least some embodiments, the coefficient adaptation component 230 may include a plurality of integrator components 260(0)-260(n) (e.g., adaptation arithmetic logic), in which each integrator component 260(n) generates or updates one of a plurality of coefficients, cₖ(0)-cₖ(n), respectively. For each integrator component 260, the coefficient adaptation component 230 may include a corresponding first mixer 250, a corresponding multiplexer (Mux) having a first input of “0” and a second input coupled to the output of the first mixer 250, and a corresponding second mixer 255. For example, in each signal path for a corresponding integrator component 260, the corresponding first mixer 250 multiplies a processed data bit after a respective delay of one period that is introduced by a respective delay stage component 245 with the quantized error value, q(εₖ), corresponding to the processed data bit (which is also delayed by one period introduced by a delay stage component 240). The output of the corresponding first mixer 250 is provided as an input to a corresponding multiplexer (Mux), which has a select line coupled to the output of the pattern identify component 235. Based on the output of the pattern identify component 235 (discussed below), the output of the corresponding multiplexer (Mux) is provided to the corresponding second mixer 255, which multiplies the output of the corresponding multiplexer (Mux) with an update gain, β. The output of the corresponding second mixer 255 is provided to the corresponding integrator component, which may then calculate or determine a value for a corresponding coefficient, cₖ.

The pattern identify component 235 performs a comparison of the logical values of a first received (and processed) data bit, such as \hat{d}ₖ, at a first period of time, and a subsequently received (or second) data bit, such as \hat{d}ₖ₊₁, at a subsequent period of time. In one embodiment, when the logical value of the first data bit is equal to the logical value of the second data bit, the pattern identify component 235 may trigger or cause an enable signal to be asserted (e.g., a logical “1”). The output of the pattern identify component 235 is coupled to the select line of each of multiplexers Mux(0)-Mux(n) of the coefficient adaptation component 230. When the enable signal is asserted, each of multiplexers Mux(0)-Mux(n), causes the output of the corresponding first mixer 250 to be provided to the corresponding second mixer 255. On the other hand, when the enable signal is not asserted (e.g., a logical “0”), each multiplexer causes a value of “0” to be provided to the corresponding second mixer 255 so that the corresponding integrator component maintains the previously determined value of a corresponding coefficient, cₖ. In this manner, the coefficient adaptation operation is performed, using the first data bit, when the logical value of the first data bit is equal to the logical value of the second data bit.

For example, in the example described, the coefficient adaptation operations of the coefficient adaptation component 230 may be expressed as follows:

$$\{ \begin{matrix}{c}_{k + 1} ( i ) = {c}_{k} ( i ) + β q ( {ɛ}_{k} ) {\hat{d}}_{i + k} & if {\hat{d}}_{k} = {\hat{d}}_{k + 1} \\ {c}_{k + 1} ( i ) = {c}_{k} ( i ) & else\end{matrix} \qquad ( Eq . 2 )$$

which represents the coefficient adaptation component 230 performing a coefficient adaptation operation when the logical value of the first data bit is equal to the logical value of the second data bit.

For alternative embodiments, when the logical value of the first data bit is opposite the logical value of the second data bit, the pattern identify component 235 may trigger or cause an enable signal to be asserted (e.g., a logical “1”). For the alternative embodiments, the coefficient adaptation operations of the coefficient adaptation component 230 may be expressed as follows:

$$\{ \begin{matrix}{c}_{k + 1} ( i ) = {c}_{k} ( i ) + β q ( {ɛ}_{k} ) {\hat{d}}_{i + k} & if {\hat{d}}_{k} = - {\hat{d}}_{k + 1} \\ {c}_{k + 1} ( i ) = {c}_{k} ( i ) & else\end{matrix} \qquad ( Eq . 3 )$$

which represents the coefficient adaptation component 230 performing a coefficient adaptation operation when the logical value of the first data bit is opposite the logical value of the second data bit.

By enabling the coefficient adaptation component 230 to perform a coefficient adaptation operation only under a certain condition, the coefficient adaptation component 230 may adapt the coefficient(s) of the DFE 200 more efficiently than conventional DFEs. The presence of a large pre-cursor of a subsequent (or second) data bit will not detrimentally effect the error value, εₖ, and/or the quantized error value, q(ε₁), of the first data bit.

FIG. 2B illustrates another example of a DFE 270, such as the DFE 102 of the receiver 100 of FIG. 1, in another embodiment. The DFE 270 is similar to the DFE 200 of FIG. 2A, but has a different coefficient adaptation component 280 than the coefficient adaptation component 230 of the DFE 200 of FIG. 2A. The coefficient adaptation component 280 may include a pattern identify component 235, such as the pattern identify component 235 as described in FIG. 2A, but has fewer delay stage components than the coefficient adaptation component 230 of the DFE 200 of FIG. 2A. For example, instead of using a delay stage component 240 and a plurality of delay stage components 245(0)-245(n) as illustrated in FIG. 2A, the coefficient adaptation component 280 of FIG. 2B may include the delay stage component 240 and just a single delay stage component 290.

FIG. 3A is an illustrative flow chart depicting an exemplary operation or method 300 of a receiver in accordance with the present embodiments. As described above, the present embodiments allow a receiver of a network-enabled device, such as the receiver 100 of FIG. 1, to control the coefficient adaptation process of its DFE, such as the DFE 102. Referring also to FIGS. 1, 2A, and 2B, the receiver 100 receives, over a communication channel, a first data bit at a first period of time and processes the first data bit using the DFE 102 of the receiver 100 (302). The receiver 100 receives a subsequent data bit at a next, subsequent period of time and processes the subsequent data bit using the DFE 102 (304).

A pattern identify component, such as the pattern identify component 104 of FIG. 1, compares the logical values of the received data bits and determines whether the logical value of the first data bit is equal to the logical value of the second, or subsequent data bit (306). If the logical value of the first data bit is equal to the logical value of the subsequent data bit, the DFE 102 performs a coefficient adaptation operation using the first data bit to adjust one or more coefficients of the DFE 102 (308). Conversely, if the logical value of the first data bit is opposite the logical value of the subsequent data bit, the DFE 102 does not perform a coefficient adaptation operation (310). The process may continue with the next subsequent data bit received by the receiver 100. In this manner, the coefficient(s) of the DFE 102 may be adjusted for a received data bit when the pre-cursor of the subsequent data bit does not detrimentally influence the error value corresponding to the received data bit. When it is determined that the pre-cursor may detrimentally influence the error value, the value(s) of the coefficient(s) may be maintained with their previous value(s).

FIG. 3B is an illustrative flow chart depicting an exemplary operation or method 350 of a receiver in an alternative embodiment. Referring also to FIGS. 1, 2A, and 2B, the receiver 100 receives, over a communication channel, a first data bit at a first period of time and processes the first data bit using the DFE 102 of the receiver 100 (352). The receiver 100 receives a subsequent data bit at a next, subsequent period of time and processes the subsequent data bit using the DFE 102 (354).

A pattern identify component, such as the pattern identify component 104 of FIG. 1, compares the logical values of the received data bits and determines whether the logical value of the first data bit is equal to the logical value of the second, or subsequent data bit (356). If the logical value of the first data bit is opposite the logical value of the subsequent data bit, the DFE 102 performs a coefficient adaptation operation using the first data bit to adjust one or more coefficients of the DFE 102 (358). Conversely, if the logical value of the first data bit is equal to the logical value of the subsequent data bit, the DFE 102 does not perform a coefficient adaptation operation (360). The process may continue with the next subsequent data bit received by the receiver 100.

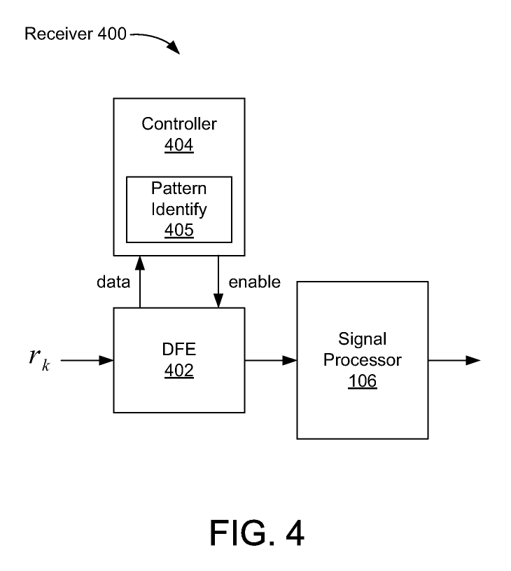

FIG. 4 is a block diagram of another receiver 400 in accordance with the present embodiments. The receiver 400 of FIG. 4 is similar to the receiver 100 of FIG. 1, except that the pattern identify component 405 of the receiver 400 is implemented by a controller 404 that is coupled to the DFE 402. In one example, the controller 404 may be coupled to memory resources, such as a non-transitory computer-readable medium (e.g., one or more nonvolatile memory elements, such as EPROM, EEPROM, Flash memory, a hard drive, etc.) that stores instructions for performing operations described above with respect to, for example, FIGS. 3A and 3B.

In one embodiment, the pattern identify component 405 may receive a first data bit and a subsequent data bit from the DFE 402 (e.g., via the data and error generation component of the DFE 402), and may compare the logical values of the data bits to determine whether a coefficient adaptation operation should be performed using the first data bit. If the logical value of the first data bit is equal to the logical value of the subsequent data bit, the pattern identify component 405 triggers or asserts an enable signal to cause the coefficient adaptation component of the DFE 402 to perform a coefficient adaptation operation using the first data bit to adjust one or more coefficients of the DFE 402. In an alternative embodiment, the pattern identify component 405 may trigger or assert an enable signal to cause the coefficient adaptation component of the DFE 402 to perform a coefficient adaptation operation using the first data bit only when the logical value of the first data bit is opposite the logical value of the subsequent data bit.

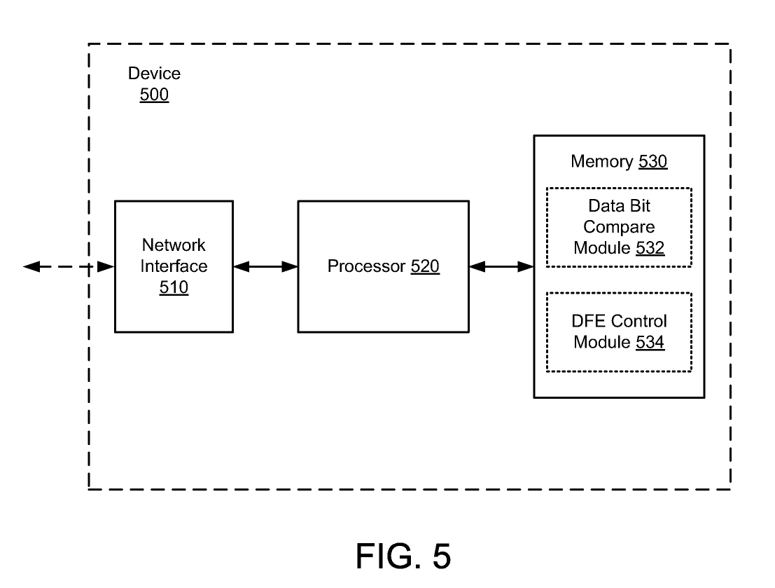

FIG. 5 shows a network-enabled device 500 that is one embodiment of a network-enabled device that may operate receiver 100 of FIG. 1 and/or receiver 400 of FIG. 4. In at least one embodiment, the device 500 includes a network interface 510, a processor 520, and a memory 530. The network interface 510 may include, for example, a receiver comprising a DFE. The network interface 510 may be used to communicate with one or more other network-enabled devices either directly or via one or more intervening networks. Processor 520, which is coupled to the network interface 510 and the memory 530, may be any suitable processor capable of executing scripts or instructions stored in the device 500 (e.g., within memory 530). In one embodiment, the processor 520 may execute instructions stored in the memory 530 to control the DFE by enabling the DFE to perform a coefficient adaptation operation only when the logical value of a first received data bit is equal to the logical value of a second data bit. In the alternative, the instructions stored in the memory 530 may be executed so that the processor 520 enables the DFE to perform a coefficient adaptation operation only when the logical value of a first received data bit is opposite the logical value of a second data bit.

Memory 530 may include a non-transitory computer-readable medium (e.g., one or more nonvolatile memory elements, such as EPROM, EEPROM, Flash memory, a hard drive, and so on) that may store the following software modules:
a data bit compare module 532 to compare the logical values of a first data bit and a subsequent data bit; and
a DFE control module 534 to determine whether to assert an enable signal to control the coefficient adaptation component of the DFE based on the compared logical values of the first data bit and the subsequent data bit.
   Each software module may include instructions that, when executed by the processor 520, may cause the device 500 to perform the corresponding function. Thus, the non-transitory computer-readable storage medium of memory 530 may include instructions for performing all or a portion of the operations 300 described above with respect to FIGS. 3A and/or 3B.

The processor 520, which is coupled to network interface 510 and memory 530, may execute scripts or instructions stored within the memory 530 to control the coefficient adaptation process of the DFE. For example, the processor 520 may execute the data bit compare module 532 and the DFE control module 534.

In some embodiments, the data bit compare module 532 may be executed by the processor 520 to compare the logical values of a first received data bit and a second (subsequent) received data bit. For example, the data bits may be received, over a communication channel from another network-enabled device, by the receiver of the network interface 510. The receiver may include a DFE having a data and error generation component, such as the data and error generation component discussed above with respect to FIGS. 2A and 2B, and may process the received data bits. The processor 520 may receive the data bits from the DFE of the receiver, and use the data bit compare module 532 to compare the logical value of the first data bit and the logical value of the second data bit and determine whether the logical value of the first data bit is equal to the logical value of the second data bit.

The DFE control module 534 may also be executed by the processor 520 to determine whether to assert an enable signal to control the coefficient adaptation component of the DFE, such as the coefficient adaptation component discussed above with respect to FIGS. 2A and 2B. Based on the comparison of the logical values using the data bit compare module 532, the processor may use the DFE control module 534 to trigger or assert an enable signal when it is determined that the logical value of the first data bit is equal to the logical value of the second data bit. As discussed above, in the alternative, the processor 520 may execute the DFE control module 534 to trigger or assert an enable signal when it is determined that the logical value of the first data bit is opposite the logical value of the second data bit.

In the foregoing specification, the present embodiments have been described with reference to specific exemplary embodiments thereof. It will, however, be evident that various modifications and changes may be made thereto without departing from the broader scope of the disclosure as set forth in the appended claims. The specification and drawings are, accordingly, to be regarded in an illustrative sense rather than a restrictive sense. For example, method depicted in the flow charts of FIGS. 3A and 3B may be performed in other suitable orders and/or one or more methods steps may be omitted.

What is claimed is:

1. A non-transitory computer-readable medium storing instructions that, when executed by a processor within a receiver, causes the receiver to:
receive, over a channel from a transmitter, a first data bit at a first period of time, the first data bit having either a first logical value corresponding to a voltage greater than zero volts or a second logical value corresponding to a voltage less than or equal to zero volts;
receive, over the channel from the transmitter, a second data bit at a second period of time subsequent to the first period of time, the second data bit having either the first logical value or the second logical value; and
perform a coefficient adaptation operation, using the first data bit, to adjust one or more coefficients of a decision feedback equalizer (DFE) of the receiver only when the logical value of the first data bit is equal to the logical value of the second data bit.

2. The non-transitory computer-readable medium of claim 1, wherein the coefficient adaptation operation is based, at least in part, on a quantized error value provided by the DFE.

3. The non-transitory computer-readable medium of claim 1, wherein the one or more coefficients of the DFE are to offset intersymbol interference caused by post-cursors.

4. The non-transitory computer-readable medium of claim 1, wherein the DFE is to perform the coefficient adaptation operation in response to receiving a trigger signal when the logical value of the first data bit is equal to the logical value of the second data bit.

5. The non-transitory computer-readable medium of claim 1, wherein execution of the instructions causes the receiver to maintain a previous value of each of the one or more coefficients of the DFE when the logical value of the first data bit is opposite the logical value of the second data bit.

6. A decision feedback equalizer (DFE), comprising:
a data and error generation component including an input signal path to receive, over a channel from a transmitter, (i) a first data bit at a first period of time, the first data bit having either a first logical value corresponding to a voltage greater than zero volts or a second logical value corresponding to a voltage less than or equal to zero volts, and (ii) a second data bit at a second period of time subsequent to the first period of time, the second data bit having either the first logical value or the second logical value;
a feedback equalizer component; and
a coefficient adaptation component coupled to the data and error generation component and to the feedback equalizer component, wherein the coefficient adaptation component is to perform a coefficient adaptation operation, using the first data bit, to adjust one or more coefficients of the coefficient adaptation component only when the logical value of the first data bit is equal to the logical value of the second data bit.

7. The DFE of claim 6, wherein the data and error generation component is to process the first data bit and the second data bit using a data slicer.

8. The DFE of claim 6, wherein the data and error generation component is to provide a quantized error value to the coefficient adaptation component, and wherein the coefficient adaptation operation is based, at least in part, on the quantized error value.

9. The DFE of claim 6, wherein the one or more coefficients are to offset intersymbol interference caused by post-cursors.

10. The DFE of claim 9, wherein the feedback equalizer component includes one or more delay stages, wherein a corresponding output of each of the one or more delay stages is provided to a corresponding mixer of one or more mixers, and wherein each of the one or more mixers is to multiply the corresponding output with a corresponding coefficient of the one or more coefficients.

11. The DFE of claim 6, wherein the coefficient adaptation component includes a pattern identify component that is to compare the logical value of the first data bit and the logical value of the second data bit.

12. The DFE of claim 11, wherein the pattern identify component is to output an enable signal when the logical value of the first data bit is equal to the logical value of the second data bit.

13. The DFE of claim 12, wherein the coefficient adaptation component includes one or more integrators, each of the one or more integrators coupled to a corresponding coefficient mixer of one or more coefficient mixers.

14. The DFE of claim 13, wherein the coefficient adaptation component is to perform the coefficient adaptation operation by enabling each of the one or more integrators to provide a corresponding coefficient of the one or more coefficients.

15. The DFE of claim 14, wherein the coefficient adaptation component includes one or more multiplexers coupled to the corresponding coefficient mixer of the one or more coefficient mixers, wherein the one or more multiplexers is to receive the enable signal from the pattern identify component.

16. The DFE of claim 15, wherein the coefficient adaptation component receives input from a controller that implements a pattern identify component, wherein the pattern identify component is to compare the logical value of the first data bit and the logical value of the second data bit.

17. A method of operating a receiver, the method comprising:
receiving, over a channel from a transmitter, a first data bit at a first period of time, the first data bit having either a first logical value corresponding to a voltage greater than zero volts or a second logical value corresponding to a voltage less than or equal to zero volts;
receiving, over the channel from the transmitter, a second data bit at a second period of time subsequent to the first period of time, the second data bit having either the first logical value or the second logical value;
comparing the logical value of the first data bit with the logical value of the second data bit; and
performing a coefficient adaptation operation, using the first data bit, to adjust one or more coefficients of a decision feedback equalizer (DFE) of the receiver only when the logical value of the first data bit is equal to the logical value of the second data bit.

18. The method of claim 17, wherein the DFE performs the coefficient adaptation operation in response to receiving a trigger signal when the logical value of the first data bit is equal to the logical value of the second data bit.

19. The method of claim 17, wherein the coefficient adaptation operation is based, at least in part, on a quantized error value provided by the DFE.

20. The method of claim 17, wherein the one or more coefficients of the DFE are to offset intersymbol interference caused by post-cursors.

21. A network-enabled device, comprising:
means for receiving, over a channel from a transmitter, a first data bit at a first period of time, the first data bit having either a first logical value corresponding to a voltage greater than zero volts or a second logical value corresponding to a voltage less than or equal to zero volts;
means for receiving, over the channel from the transmitter, a second data bit at a second period of time subsequent to the first period of time, the second data bit having either the first logical value or the second logical value;
means for comparing the logical value of the first data bit with the logical value of the second data bit; and
means for performing a coefficient adaptation operation, using the first data bit, to adjust one or more coefficients of a decision feedback equalizer (DFE) of the means for receiving only when the logical value of the first data bit is equal to the logical value of the second data bit.

22. The network-enabled device of claim 21, wherein the DFE is to perform the coefficient adaptation operation in response to receiving a trigger signal when the logical value of the first data bit is equal to the logical value of the second data bit.

23. The network-enabled device of claim 21, wherein the coefficient adaptation operation is based, at least in part, on a quantized error value provided by the DFE.
